(19) United States
(12) Patent Application Publication
(10) Pub. No.: US 2024/0361715 A1
(43) Pub. Date: Oct. 31, 2024

(54) HEATING DEVICE, FIXING DEVICE, AND IMAGE FORMING APPARATUS

(71) Applicants: Yoshiki YAMAGUCHI, Kanagawa (JP); Hiroshi YOSHINAGA, Chiba (JP); Takashi SETO, Kanagawa (JP); Ryohei MATSUDA, Kanagawa (JP)

(72) Inventors: Yoshiki YAMAGUCHI, Kanagawa (JP); Hiroshi YOSHINAGA, Chiba (JP); Takashi SETO, Kanagawa (JP); Ryohei MATSUDA, Kanagawa (JP)

(21) Appl. No.: 18/645,389

(22) Filed: Apr. 25, 2024

(30) Foreign Application Priority Data
Apr. 28, 2023 (JP) 2023-074325

(51) Int. Cl. G03G 15/20

(52) U.S. Cl. CPC G03G 15/2053; G03G 15/2064; G03G 2215/2035

(57) ABSTRACT

A heating device includes a first rotator, a second rotator, a heater, a nip formation pad, a reflector, and a shield. The second rotator faces the first rotator. The heater heats the first rotator. The nip formation pad is inside a loop of the first rotator to form a nip between the first rotator and the second rotator. The nip formation pad has a nip side face facing an inner circumferential surface of the first rotator. The reflector reflects radiant heat radiated from the heater toward the inner circumferential surface of the first rotator. The reflector contacts the nip side face of the nip formation pad. The shield contacts the reflector and shields the first rotator from the radiant heat radiated from the heater.

### CROSS-REFERENCE TO RELATED APPLICATION

This patent application is based on and claims priority pursuant to 35 U.S.C. § 119 (a) to Japanese Patent Application No. 2023-074325, filed on Apr. 28, 2023, in the Japan Patent Office, the entire disclosure of which is hereby incorporated by reference herein.

### BACKGROUND

### Technical Field

Embodiments of the present disclosure generally relate to a heating device, a fixing device, and an image forming apparatus.

### Related Art

One type of image forming apparatus such as a copier or a printer includes a fixing device that is a heating device heating an unfixed image transferred to a recording medium such as a sheet to fix the unfixed image onto the recording medium.

A typical fixing device includes a pair of rotators contacting each other to form a nip and a heater heating at least one of the rotators. The sheet bearing the unfixed image enters the nip between the pair of rotators, and the pair of rotators heats and presses the unfixed image to fix the unfixed image onto the sheet.

### SUMMARY

This specification describes an improved heating device that includes a first rotator, a second rotator, a heater, a nip formation pad, a reflector, and a shield. The second rotator faces the first rotator. The heater heats the first rotator. The nip formation pad is inside a loop of the first rotator to form a nip between the first rotator and the second rotator. The nip formation pad has a nip side face facing an inner circumferential surface of the first rotator. The reflector reflects radiant heat radiated from the heater toward the inner circumferential surface of the first rotator. The reflector contacts the nip side face of the nip formation pad. The shield contacts the reflector and shields the first rotator from the radiant heat radiated from the heater.

This specification also describes an improved heating device that includes a first rotator, a second rotator, a heater, a nip formation pad, a high thermal conductor, a reflector, and a shield. The second rotator faces the first rotator. The heater heats the first rotator. The nip formation pad is inside a loop of the first rotator to form a nip between the first rotator and the second rotator. The high thermal conductor is between the nip formation pad and an inner circumferential surface of the first rotator. The high thermal conductor has thermal conductivity higher than thermal conductivity of the nip formation pad. The reflector reflects radiant heat radiated from the heater toward an inner circumferential surface of the first rotator. The reflector contacts the high thermal conductor. The shield contacts the reflector and shields the first rotator from the radiant heat radiated from the heater.

This specification further describes an image forming apparatus including the fixing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus according to a first embodiment of the present disclosure;

FIG. 2 is a schematic diagram illustrating a configuration of a fixing device installed in the image forming apparatus of FIG. 1;

FIG. 3 is a perspective view of the fixing device according to the first embodiment;

FIG. 4 is an exploded perspective view of a part of the fixing device according to the first embodiment including a nip formation pad, a high thermal conductor, a reflector, and a shield;

FIG. 5 is a diagram to illustrate an arrangement of heat generation portions of halogen heaters and shields;

FIG. 6 is a schematic diagram to illustrate an arrangement of a contact of a reflector and a contact of a shield;

FIG. 7 is an exploded perspective view of a part of the fixing device according to a second embodiment including a nip formation pad, a high thermal conductor, a reflector, and a shield;

FIG. 8 is a perspective view of a part of assembly after the reflector of FIG. 7 and the shield of FIG. 7 are assembled;

FIG. 9 is a schematic diagram illustrating a configuration of a fixing device according to a third embodiment of the present disclosure;

FIG. 10 is a graph illustrating a relation between the temperature of lubricant and the concentration of fine particles generated from the lubricant; and

FIG. 11 is a perspective view of a sample container.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a,” “an,” and “the” are intended to include the plural forms as well, unless the context clearly indicates otherwise.

With reference to drawings, descriptions are given below of embodiments of the present disclosure. In the drawings for illustrating embodiments of the present disclosure, elements or components identical or similar in function or shape are given identical reference numerals as far as distinguishable, and redundant descriptions are omitted.

### <Structure of Image Forming Apparatus>

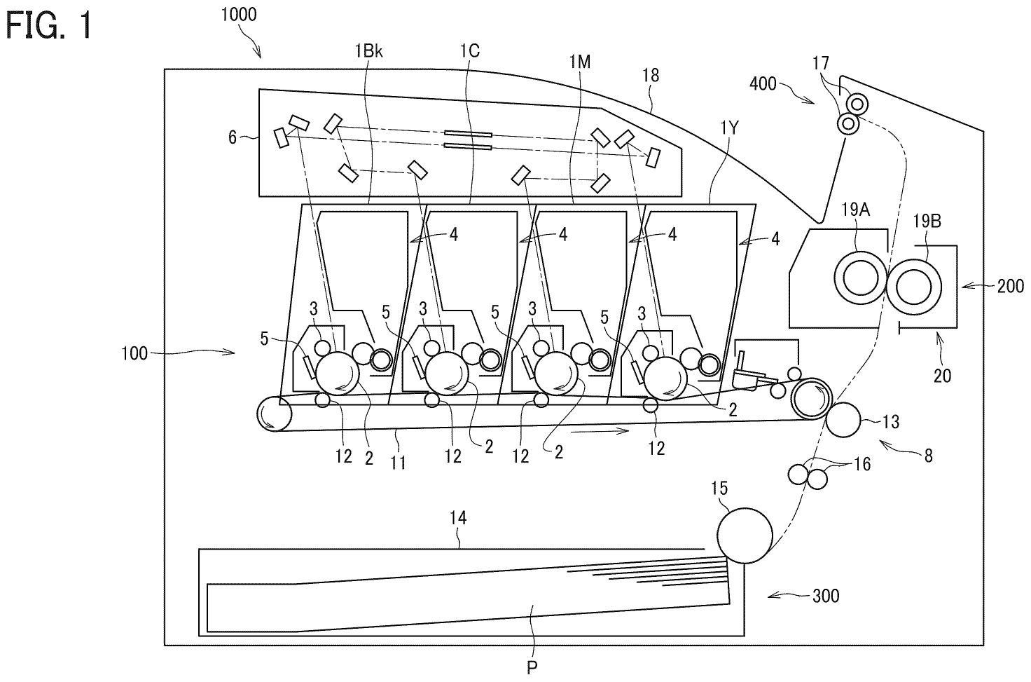

FIG. 1 is a schematic diagram illustrating a configuration of an image forming apparatus according to a first embodiment of the present disclosure. In the following description, the term “image forming apparatus” includes a printer, a copier, a facsimile machine, or a multifunction peripheral having at least two of printing, copying, scanning, and facsimile functions. The term “image formation” includes the formation of images with meanings such as characters and figures and the formation of images with no meanings such as patterns. Initially, with reference to FIG. 1, a description is given below of the overall configuration and operation of an image forming apparatus 1000 according to the first embodiment of the present disclosure.

As illustrated in FIG. 1, the image forming apparatus 1000 according to the first embodiment of the present disclosure includes an image forming section 100, a fixing section 200, a recording medium feeder 300, and a recording medium ejection section 400.

### (Image Forming Section)

The image forming section 100 forms an image on a sheet-shaped recording medium such as a sheet. The image forming section 100 includes four image forming units 1Y, 1M, 1C, and 1Bk, an exposure device 6, and a transfer device 8.

The image forming units 1Y, 1M, 1C, and 1Bk have the same configuration except for containing different color toners (developers), i.e., yellow (Y), magenta (M), cyan (C), and black (Bk) toners, respectively, corresponding to decomposed color separation components of a full-color image. Each of the image forming units 1Y, 1M, 1C, and 1Bk includes a photoconductor 2, a charger 3, a developing device 4, and a cleaner 5.

The photoconductor 2 bears an electrostatic latent image on its surface and rotates. Examples of the photoconductor 2 include an endless belt-shaped photoconductor in addition to a drum-shaped photoconductor as illustrated in FIG. 1.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be selected as appropriate depending on the purpose. Specifically, examples of the charger 3 include a contact type charger such as a conductive or semiconductive charging roller, a magnetic brush, a fur brush, a film, or a rubber blade, and a non-contact type charger using corona discharge.

The developing device 4 supplies toner as the developer to the electrostatic latent image of the photoconductor 2 to form a toner image. The developing device 4 includes a toner bearer disposed in contact with or adjacent to the photoconductor 2. The toner bearer bears the toner on the surface of the toner bearer and rotates to supply toner from the toner bearer to the photoconductor 2.

The cleaner 5 removes the toner and other foreign matters remaining on the photoconductor 2. Examples of the cleaner 5 include a cleaning blade disposed to be in contact with the surface of the photoconductor 2. While the photoconductor 2 rotates, the cleaner 5 removes the residual toner and foreign matters on the photoconductor 2.

The exposure device 6 exposes the charged surface of the photoconductor 2 to form an electrostatic latent image on the surface of the photoconductor 2.

The exposure system of the exposure device 6 is not limited to a particular system as long as the exposure device 6 can expose the charged surface of the photoconductor 2. The exposure system can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers an image onto a recording medium. The transfer device 8 includes an intermediate transfer belt 11, primary transfer rollers 12, and a secondary transfer roller 13. The intermediate transfer belt 11 is an endless belt stretched by a plurality of support rollers. Four primary transfer rollers 12 are disposed inside the loop of the intermediate transfer belt 11. Each of the primary transfer rollers 12 is in contact with the corresponding photoconductor 2 via the intermediate transfer belt 11 to form a primary transfer nip between the intermediate transfer belt 11 and each photoconductor 2. The secondary transfer roller 13 is in contact with the outer circumferential surface of the intermediate transfer belt 11 to form a secondary transfer nip.

### (Fixing Section)

The fixing section 200 fixes the image onto a recording medium. The fixing section 200 includes a fixing device 20 that heats the recording medium to fix the image onto the recording medium. The fixing device 20 includes a pair of rotators 19A and 19B contacting each other to form a nip.

### (Recording Medium Feeder)

The recording medium feeder 300 supplies the recording medium to the image forming section 100. The recording medium feeder 300 includes a sheet tray 14 to store sheets P as recording media and a feed roller 15 to feed the sheet P from the sheet tray 14. Although a “recording medium” is described as a “sheet of paper,” which is referred to simply as “sheet” in the following description, the “recording medium” is not limited to the sheet of paper. Examples of the “recording medium” include not only a sheet of paper but also an overhead projector (OHP) transparency sheet, a fabric, a metallic sheet, a plastic film, and a prepreg sheet including carbon fibers previously impregnated with resin. Examples of the “sheet” include thick paper, a postcard, an envelope, thin paper, coated paper (e.g., coat paper and art paper), and tracing paper, in addition to plain paper.

### (Recording Medium Ejection Section)

The recording medium ejection section 400 ejects the sheet P to the outside of the image forming apparatus 1000. The recording medium ejection section 400 includes an output roller pair 17 to eject the sheet P to the outside of the image forming apparatus 1000 and an output tray 18 to place the sheet P ejected by the output roller pair 17.

### <Image Forming Operation>

To provide a fuller understanding of the embodiments of the present disclosure, a description is now given of the image forming operation of the image forming apparatus 1000 according to the present embodiment, with continued reference to FIG. 1.

In response to starting the image forming operation, the photoconductors 2 in the image forming units 1Y, 1M, 1C, and 1Bk and the intermediate transfer belt 11 in the transfer device 8 start rotating. The feed roller 15 starts rotating to feed the sheet P from the sheet tray 14. The sheet P fed from the sheet tray 14 is brought into contact with a timing roller pair 16 and temporarily stopped until the image forming section 200 forms the image to be transferred to the sheet P.

In each of the image forming units 1Y, 1M, 1C, and 1Bk, the charger 3 uniformly charges the surface of the photoconductor 2 at a high electric potential. Based on image data of a document read by a document reading device or print data instructed to print by a terminal, the exposure device 6 exposes the charged surface of each of the photoconductors 2. As a result, the electric potential at an exposed portion on the surface of each of the photoconductor 2 is decreased. Thus, the electrostatic latent image is formed on the surface of each of the photoconductors 2. The developing device 4 supplies toner to the electrostatic latent image formed on the photoconductor 2 to develop the electrostatic latent image and form the toner image on the photoconductor 2. As the photoconductor 2 rotates, the toner image that is thus formed on the photoconductor 2 reaches the primary transfer nip defined by the primary transfer roller 12. At the primary transfer nip, the toner image is transferred onto the intermediate transfer belt 11 rotating. Specifically, the toner images are sequentially transferred from the respective photoconductors 2 onto the intermediate transfer belt 11 such that the toner images are superimposed one atop another, as a composite full-color toner image on the intermediate transfer belt 11. Thus, the full-color toner image is formed on the intermediate transfer belt 11. The image forming operation is not limited to the above-described full color image forming operation that uses all four image forming units 1Y, 1M, 1C, and 1Bk. Alternatively, the image forming apparatus 1000 can form a monochrome toner image by using any one of the four process units 1Y, 1M, 1C, and 1Bk, or can form a bicolor toner image or a tricolor toner image by using two or three of the process units 1Y, 1M, 1C, and 1Bk. After the toner image is transferred to the intermediate transfer belt 11, the cleaner 5 removes the residual toner that remains on the photoconductor 2 from the surface of the photoconductor 2.

In accordance with the rotation of the intermediate transfer belt 11, the toner image transferred onto the intermediate transfer belt 11 is conveyed to the secondary transfer nip (the position of the secondary transfer roller 13) and is transferred onto the sheet P conveyed by the timing roller pair 16. Subsequently, the sheet P is conveyed to the fixing device 20 and passes through the nip between the pair of rotators 19A and 19B that are in contact with each other. At this time, the pair of rotators 19A and 19B applies heat and pressure to the sheet P to fix the toner image onto the sheet P. Then, the sheet P bearing the fixed toner image is conveyed to the recording medium ejection section 400. In the recording medium ejection section 400, the output roller pair 17 ejects the sheet P onto the output tray 18. As described above, a series of image forming operations are completed.

### <Basic Configuration of Fixing Device>

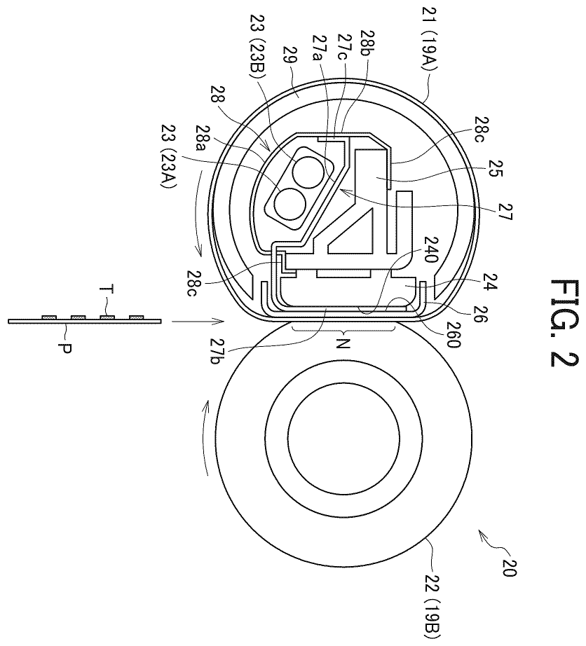

A basic configuration of the fixing device 20 according to a first embodiment of the present disclosure is described with reference to FIG. 2.

As illustrated in FIG. 2, the fixing device 20 according to the first embodiment of the present disclosure includes halogen heaters 23, a nip formation pad 24, a support 25, a high thermal conductor 26, a reflector 27, shields 28, and rotator holders 29 in addition to the pair of rotators 19A and 19B.

The pair of rotators 19A and 19B includes a fixing belt 21 as a first rotator and a pressure roller 22 as a second rotator.

The fixing belt 21 is disposed on an image bearing side of the sheet P on which the unfixed image is borne (in other words, a toner image T side). The fixing belt 21 is an endless belt including a base layer, an elastic layer, and a release layer successively layered from the inner circumferential surface to the outer circumferential surface. The base has, for example, a thickness of 30 μm to 50 μm and is made of metal such as nickel or stainless steel or resin such as polyimide. The elastic layer has a thickness of 100 μm to 300 μm and is made of rubber such as silicone rubber, silicone rubber foam, or fluorine rubber. The elastic layer of the fixing belt 21 eliminates slight surface asperities of the fixing belt 21 at the nip, thus facilitating uniform conduction of heat to the toner image T on the sheet P. The release layer of the fixing belt 21 has a thickness of 10 μm to 50 μm and is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image T on the sheet P from the fixing belt 21. In other words, the release layer of the fixing belt 21 facilitates the release of the toner from the fixing belt 21. To reduce the size and thermal capacity of the fixing belt 21, the fixing belt 21 preferably has a total thickness equal to or less than 1 mm and a loop diameter equal to or less than 30 mm.

The pressure roller 22 is disposed opposite an outer peripheral surface of the fixing belt 21. The pressure roller 22 includes a cored bar, an elastic layer on the outer circumferential surface of the cored bar, and a release layer on the outer circumferential surface of the elastic layer. The cored bar is made of, for example, metal such as iron. The cored bar may be solid or hollow. Examples of the material of the elastic layer include silicone rubber, silicone rubber foam, and fluororubber. The release layer is made of, for example, fluororesin such as PFA or PTFE.

The halogen heater 23 is a radiant heat type heat source that radiates infrared rays (infrared light) that generates radiant heat to heat the fixing belt 21. The radiant heat radiated from the halogen heater 23 heats the inner face of the fixing belt 21. As the heat source, other than the halogen heater, another radiant heat type heat source such as a carbon heater may be used.

The nip formation pad 24 forms the nip N between the fixing belt 21 and the pressure roller 22. The nip formation pad 24 is disposed inside the loop of the fixing belt 21 and sandwiches the fixing belt 21 together with the pressure roller 22, to form the nip N. The nip formation pad 24 is preferably made of a heat-resistant member having a heat-resistant temperature equal to or higher than 200° C. For example, the nip formation pad 24 is made of a typical heat-resistant resin such as polyether sulfone (PES), polyphenylene sulfide (PPS), liquid crystal polymer (LCP), polyether nitrile (PEN), polyamide-imide (PAI), or polyether ether ketone (PEEK). The nip formation pad 24 made of such a heat-resistant material can prevent the nip formation pad from being deformed by heat, and stabilize the shape of the nip N. Instead of the planar shape as illustrated in FIG. 2, the shape of the nip N may be a curve or another shape.

The support 25 supports the nip formation pad 24. The support 25 supports a back face of the nip formation pad 24, and a front face of the nip formation pad 24 faces the pressure roller 22. As a result, the support 25 prevents the nip formation pad 24 from being bent by the pressure of the pressure roller 22 and enables obtaining a uniform width of the nip N. The support 25 is preferably made of iron-based metal such as steel use stainless (SUS) or steel electrolytic cold commercial (SECC) to enhance the rigidity.

The high thermal conductor 26 is interposed between the inner circumferential surface of the fixing belt 21 and the nip formation pad 24 in the nip N and assists heat transfer. The high thermal conductor 26 is made of a material having a thermal conductivity higher than a thermal conductivity of the nip formation pad 24. The high thermal conductor 26 interposed between the nip formation pad 24 and the fixing belt 21 conducts heat over the nip N in the longitudinal direction of the nip N and can reduce temperature unevenness in the nip N. In general, the nip formation pad 24 is made of resin having thermal insulation properties in order to reduce heat transfer from the fixing belt 21 to the support 25 and to effectively heat the fixing belt 21. However, the heat in the nip N is less likely to conduct from the nip formation pad 24 made of material having the thermal insulation properties to other parts. As a result, continuously printing the sheets P is likely to cause an excessive temperature rise in a non-sheet passing region that is a region of the fixing belt with which the sheets P are not in contact. The high thermal conductor 26 interposed between the nip formation pad 24 and the fixing belt 21 disperses the heat from the non-sheet passing region to a sheet passing region that is a region of the fixing belt with which the sheets P are in contact to avoid the excessive temperature rise in the non-sheet passing region. Since the high thermal conductor 26 moves the heat from the non-sheet passing region to the sheet passing region, the high thermal conductor 26 can enhance the heating efficiency.

Preferably, the high thermal conductor 26 is made of a material having high thermal conductivity such as aluminum or copper. In order to enhance the sliding property of the fixing belt 21 with respect to the high thermal conductor 26, a coating layer having excellent sliding property may be formed on the surface of the high thermal conductor 26, the surface contacting the fixing belt 21. Examples of the material of the coating layer include polyimide resin, fluororesin, polyphenylene sulfide resin, and saturated polyester resin. Further, glass fiber, carbon, graphite, graphite fluoride, carbon fiber, molybdenum disulfide, or fluororesin, may be mixed with such a resin. Alternatively, the material of the coating layer may be molybdenum disulfide, nickel, composite plating of nickel and fluororesin, anodized aluminum, or anodized aluminum impregnated with resin or metal. Further, the material of the coating layer may be silicon carbide ceramic, silicon nitride ceramic, alumina ceramic, or a mixture of these ceramics with molybdenum disulfide or fluororesin. Alternatively, an anodized aluminum layer as the coating layer on the surface of the high thermal conductor 26 made of aluminum or aluminum alloys may be formed, and molybdenum disulfide generated by secondary electrolysis may be filled in the fine pores of the anodized aluminum layer.

The reflector 27 reflects radiant heat emitted from the halogen heaters 23 toward the fixing belt 21. The reflector 27 is disposed opposite the halogen heater 23 inside the loop of the fixing belt 21 to reflect radiant heat. The reflector 27 reflects the radiant heat radiated from the halogen heater 23 toward the fixing belt 21, and the reflected radiant heat effectively heats the fixing belt 21. In the present embodiment, the reflector 27 disposed between the halogen heater 23 and the support 25 prevents the radiant heat from being unnecessarily radiated to the support 25, which enables energy saving.

The reflector 27 is made of material having a higher reflectance than material of the support 25 and the shield 28. Specifically, the reflectance of the reflector 27 is 70% or more, and preferably 90% or more. The reflectance of the reflector 27 is measured using the spectrophotometer that is the ultraviolet visible infrared spectrophotometer UH4150 manufactured by Hitachi High-Technologies Corporation in which the incident angle is set to 5°.

The shield 28 is interposed between the halogen heater 23 and the fixing belt 21 and shields the fixing belt 21 from the radiant heat radiated by the halogen heater 23. The shield 28 includes a shield portion 28a and two fixed portions 28c disposed on both sides of the shield portion 28a. The shield portion 28a is disposed to face the halogen heater 23 to shield the fixing belt 21 from the radiant heat radiated by the halogen heater 23. The two fixed portions 28c are disposed on the upstream side and the downstream side of the shield portion 28a in the rotation direction of the fixing belt 21 and fixed to the support 25. Fixing two portions, which are the upstream portion and the downstream portion, of the shield 28 on the support 25 in this way enables the support 25 to stably support the shield 28. The material of the shield 28 may be any material that can shield the fixing belt from the radiant heat. The material of the shield 28 is preferably material having thermal resistance, for example, metal such as aluminum, iron, or stainless steel, or ceramics. The shield 28 may absorb or reflect radiant heat.

As illustrated in FIG. 3, the shields 28 in the present embodiment are disposed in the non-sheet-passing regions W2 outside the region W1 through which the sheet P having the largest width of widths of sheets used in the image forming apparatus passes (which is referred to as the maximum-recording-medium passing region). The above-described configuration shields the non-sheet-passing region W2 of the fixing belt 21 from the radiant heat to reduce the temperature rise in the non-sheet-passing region W2 of the fixing belt 21. On the other hand, the radiant heat is radiated to the sheet-passing region W1 where the shield 28 is not disposed, and thus the fixing belt 21 is reliably heated.

The halogen heater 23 has a feature that a heat generation amount at each of the ends of the heat generation region is lower than a heat generation amount at the center of the heat generation region. Accordingly, arranging the end of the heat generation region having the lower heat generation amount in the sheet-passing region may cause a shortage of an amount of heat applied to the end of the sheet on the end of the sheet-passing region in the width direction of the sheet-passing region. Arranging the end of the heat generation region outside the sheet-passing region avoids the shortage of the amount of heat applied to the end of the sheet on the end of the sheet-passing region in the width direction. However, the radiant heat radiated from the end of the heat generation region in the non-sheet-passing region outside the sheet-passing region may cause an excessive temperature rise in the non-sheet-passing region of the fixing belt 21 when sheets continuously pass through the fixing device. To countermeasure the excessive temperature rise in the present embodiment, providing the shield 28 that shields the non-sheet-passing region of the fixing belt 21 from the radiant heat reduces the excessive temperature rise in the non-sheet-passing region of the fixing belt 21. The above-described configuration can satisfactorily heat the sheet-passing region of the fixing belt 21. The shield 28 may completely shield the radiant heat or may shield a part of the radiant heat.

As illustrated in FIG. 3, a pair of rotator holders 29 are disposed at both ends of the fixing belt 21 in the longitudinal direction X of the fixing belt 21 to rotatably hold the fixing belt 21. The above-described longitudinal direction means a direction orthogonal to the rotation direction of the fixing belt 21 and along the outer circumferential surface of the fixing belt 21. The “longitudinal direction” is a direction indicated by an arrow X in FIG. 3 and is the same direction as the longitudinal direction of the pressure roller 22, the rotation axis direction of the pressure roller 22, and the width direction of the sheet passing through the nip N (that is the direction intersecting with the sheet conveyance direction).

Each of the pair of rotator holders 29 includes a holder 29a having a C-shape, a restrictor 29b, and a fixed portion 29c. The holder 29a is inserted into the end of the fixing belt 21. Inserting the holders 29a into both ends of the loop of the fixing belt 21 rotatably holds the fixing belt 21. The restrictor 29b has an outer diameter larger than the outer diameter of holder 29a and the outer diameter of the loop of the fixing belt 21. In the above-described configuration, the edge of the fixing belt 21 skewed in the longitudinal direction X abuts against the restrictor 29b so that the skew of the fixing belt 21 in the longitudinal direction X is restricted. The fixed portion 29c is fixed to a frame such as a side plate of the fixing device 20. Since the fixed portion 29c is fixed to the frame, the rotator holders 29 can rotatably support the fixing belt 21.

The fixing device 20 according to the first embodiment of the present disclosure operates as follows.

When the image forming operation starts, a driver starts rotating the pressure roller 22 in a direction indicated by an arrow in FIG. 2, and the rotation of the pressure roller 22 rotates the fixing belt 21. The radiant heat radiated from the halogen heater 23 heats the fixing belt 21. After the temperature of the fixing belt 21 reaches a temperature that can fix the image onto the sheet P, the sheet P bearing an unfixed toner image (the toner image T) is conveyed to the nip N between the fixing belt 21 and the pressure roller 22. As a result, the sheet P and the unfixed image are heated and pressed, and the unfixed image is fixed to the sheet P. The sheet P passes through the nip N and is ejected from the fixing device 20.

### <Problem Due to Temperature Rise of Shield>

The following describes a problem caused by the temperature rise of the shield 28.

The shield 28 shields the fixing belt from the radiant heat radiated by the halogen heater 23 to reduce the temperature rise of the fixing belt 21, but the shield 28 itself is exposed to the radiant heat from the halogen heater 23, which causes a temperature rise of the shield 28. The temperature rise of the shield 28 causes a temperature rise of the rotator holder 29 disposed near the shield 28.

The temperature rise of the rotator holder 29 causes a temperature rise of lubricant adhered to the rotator holder 29, which may generate fine particles. The lubricant is applied to the rotator holder 29 to enhance the slidability of the fixing belt 21 with respect to the rotator holder 29. An example of the lubricant is a liquid or semi-solid substance having lubricity, such as silicone oil, silicone grease, fluorine oil, or fluorine grease. The temperature rise of the lubricant volatilizes a part of the low-molecular components of the lubricant, and the volatilized components are cooled by air and aggregated. As a result, fine particles are generated.

Currently, due to an increase in the awareness of environmental issues, the reduction of fine particles discharged from products has been desired. The image forming apparatuses that reduce the generation of fine particles are also to be developed. Environmental concerns are very high, especially in Europe. There are various authorization standards for volatile organic compounds (VOC), ozone, dust, and fine particles that are generated during image formation in electrophotographic image forming apparatuses such as copiers, printers, or multifunction peripherals. For example, the Blue Angel has been the ecolabel of the German Federal Government. Only certified products and services are permitted to use the label.

The Blue Angel certification requires various tests to be cleared. In particular, tests for fine particles are very strict. Specifically, the number of fine particles of 5.6 nm to 560 nm that are generated from the image forming apparatus and measured by the FAST MOBILITY PARTICLE SIZER (FMPS) is required to be less than 3.5×10¹¹/10 minutes. A stricter reference value may be set in the future. The “fine particles” described in this specification mean fine particles including ultrafine particles (that are referred to as “FP/UFP” below) measured by an apparatus and conditions in conformity with the fine particles standard of Blue Angel and mean particles having a particle size of 5.6 nm or more and 560 nm or less.

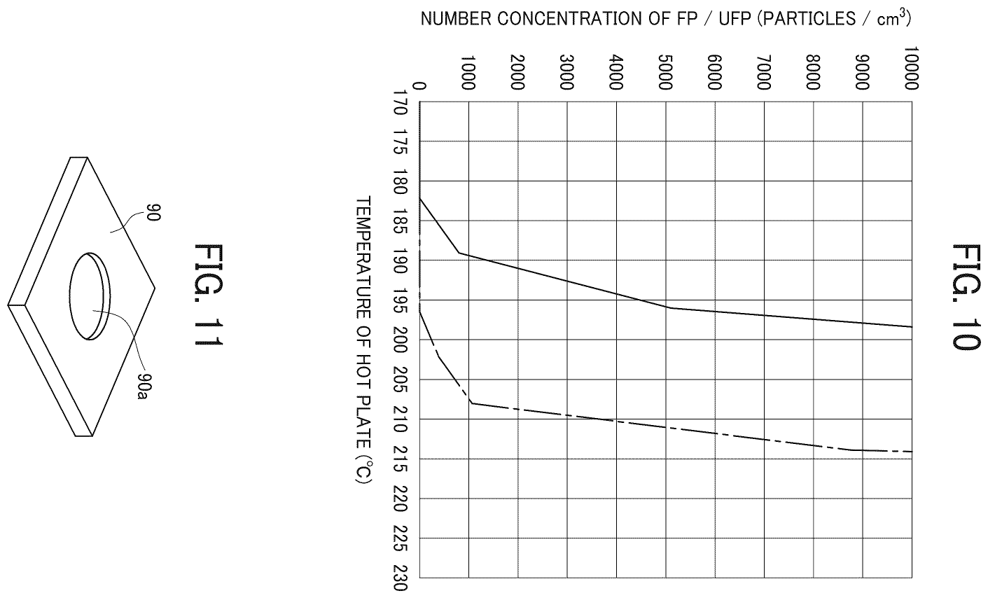

FIG. 10 is a graph illustrating a relation between the temperature of lubricant and the concentration of FP/UFP generated from the lubricant (that is the number of fine particles per 1 cm³). In FIG. 10, the solid line indicates the number concentration of FP/UFP generated from the fluorine grease, whereas the alternate long and short dash line indicates the number concentration of FP/UFP generated from the silicone oil.

Fluorine grease and silicone oil were heated in a chamber having 1 m³ (ventilation frequency: 5 times) based on the Japanese Industrial Standard JIS A 1901, and the generation concentrations of FP/UFP were measured. As a result, the generation concentrations of FP/UFP illustrated in FIG. 10 were obtained. As illustrated in FIG. 11, an aluminum plate 90 of 50 mm×50 mm×5 mm provided with a recess 90a having a diameter of 22 mm and a depth of 2 mm was used as a sample container to place the fluorine grease and the silicone oil. Fluorine grease 36 μl and the silicone oil 36 μl were separately placed in different recesses 90a of sample containers, and sample containers were placed on a hot plate of a heater (Clean Hot Plate MH-180CS manufactured by AS ONE Corporation, Controller MH-3CS manufactured by AS ONE Corporation). The fluorine grease and the silicone oil were heated at a preset temperature of 250° C. While the temperature of the hot plate was monitored, the number concentration of FP/UFP in the chamber was measured with a measuring device (FAST MOBILITY PARTICLE SIZER (FMPS) Model 3091 manufactured by TSI Incorporated), with the Use Averaging Interval at Export of 30 seconds. Since the temperatures of the fluorine grease and the silicone oil change substantially in synchronization with the temperature of the hot plate, the temperature of the hot plate is illustrated on the horizontal axis as the temperatures of the fluorine grease and the silicone oil in FIG. 10.

As indicated by the solid line in FIG. 10, the generation of FP/UFP from the fluorine grease started when the temperature reached about 185° C. The number concentration of FP/UFP generated from the fluorine grease started rapidly increasing when the temperature exceeded about 194° C. On the other hand, as indicated by the alternate long and short dash line in FIG. 10, the generation of FP/UFP from the silicone oil started when the temperature reached about 200° C. The number concentration of FP/UFP generated from the silicone oil started rapidly increasing when the temperature exceeded about 210° C.

As described above, since the FP/UFP are generated from the fluorine grease and the silicone oil when the temperature reaches 185° C. and 200° C., respectively, the FP/UFP may be generated from the lubricant in the fixing device in which the temperature exceeds 200° C. Accordingly, to prevent the occurrence of FP/UFP in the fixing device, it is important to reduce the temperature rise of the shield 28 and the temperature rise of the rotator holder 29 to which the lubricant adheres.

### <Problem Due to Temperature Rise of Reflector>

The following describes a problem caused by the temperature rise of the reflector 27.

Similar to the shield 28, the reflector 27 is exposed to the radiant heat from the halogen heater 23, and the radiant heat is likely to raise the temperature of the reflector 27. For example, continuously fixing a lot of images onto a lot of sheets may raise the temperature of the reflector 27 to about 400° C. exceeding 300° C.

Although the reflector 27 is made of a heat-resistant material, an excessive temperature rise in the reflector 27 may discolor the aluminum layer or the silver layer that is a reflection face of the reflector 27. Since discoloring the reflection face reduces the reflectance, the reflector 27 cannot satisfactorily reflect the radiant heat to the fixing belt 21, which causes a reduction in heating efficiency. To prevent the excessive temperature rise of the reflector 27, a controller in the image forming apparatus typically limits the number of sheets printed in unit time to stop heat generation of the halogen heater 23 or reduce the heat generation amount of the halogen heater 23 when the temperature of the reflector 27 is equal to or higher than a predetermined threshold value. However, since limiting the number of sheets printed leads to a decrease in productivity of the image forming apparatus, the temperature rise in the reflector 27 hinders increasing the productivity of the image forming apparatus.

As described above, the fixing device has problems associated with the temperature rise of the reflector 27 and the shield 28. To reduce the temperature rise of the reflector 27 and the shield 28, the fixing device according to the first embodiment of the present disclosure has the following configuration. The following describes features of the fixing device according to the first embodiment of the present disclosure.

### <Features of Fixing Device>

As illustrated in FIG. 2, the reflector 27 in the first embodiment of the present disclosure includes a reflector portion 27a and a heat conductor 27b. The reflector portion 27a is disposed to face the halogen heater 23 and reflects the radiant heat from the halogen heater 23 to the fixing belt 21. The heat conductor 27b extends from the reflector portion 27a toward the nip N to transfer heat from the reflector 27 to the high thermal conductor 26.

The heat conductor 27b is sandwiched between the nip formation pad 24 and the high thermal conductor 26. Accordingly, the heat conductor 27b contacts a nip pressing face 240 of the nip formation pad 24 and also contacts a face 260 of the high thermal conductor 26 that is opposite a face facing the nip N. The nip pressing face 240 of the nip formation pad 24 is the face to which the pressure roller 22 applies pressure via the inner peripheral face of the fixing belt 21 and the high thermal conductor 26 in the nip N. Since the heat conductor 27b contacts the nip pressing face 240 as described above, the heat conductor 27b receives the pressure between the nip pressing face 240 and the high thermal conductor 26. In other words, the nip formation pad 24 has a nip side face (that is the nip pressing face 240) facing the inner circumferential surface of the fixing belt 21 as the first rotator in the nip and a support side face contacting the support 25, and the heat conductor 27b of the reflector 27 contacts the nip side face of the nip formation pad 24.

In addition, the shield 28 in the first embodiment of the present disclosure is disposed so as to be in contact with the reflector 27. Specifically, the reflector 27 includes a contact 27c disposed at an edge of the reflector portion 27a, and the shield 28 contacts the contact 27c. In other words, the shield 28 includes a contact 28b contacting the contact 27c disposed at the edge of the reflector portion 27a. The contact 28b of the shield 28 is provided between the shield portion 28a and the fixed portion 28c upstream from the shield portion 28a in the rotation direction of the fixing belt 21.

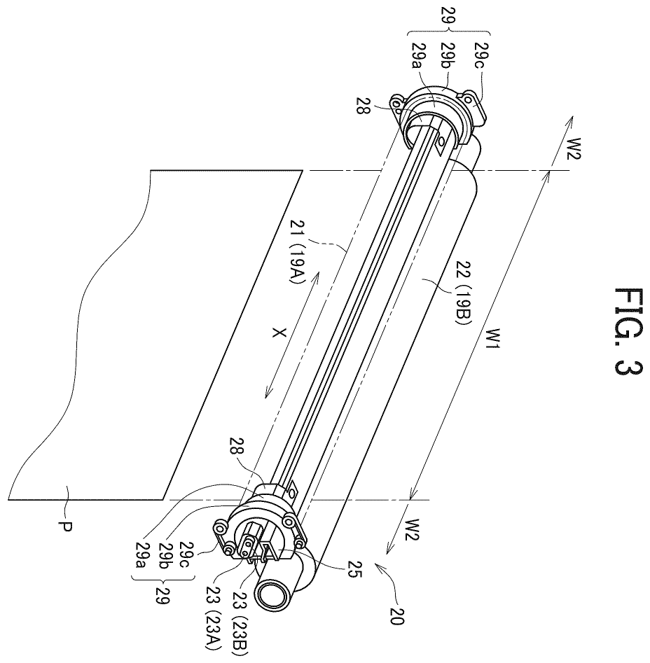

FIG. 4 is an exploded perspective view of a part of the fixing device according to the first embodiment of the present disclosure including the nip formation pad 24, the high thermal conductor 26, the reflector 27, and the shield 28.

As illustrated in FIG. 4, the reflector 27 includes a pair of contacts 27c at both ends of the reflector 27 in the longitudinal direction of the reflector 27, the contacts 27c are in contact with the contacts 28b of the shield 28. The contact 27c protrudes from each of both ends of the reflector portion 27a in the longitudinal direction toward the shield 28 and is bent.

As illustrated in FIG. 4, the heat conductor 27b of the reflector 27 is continuously arranged over the entire sheet passing region W1. As a result, the heat conductor 27b is in continuous contact with the high thermal conductor 26 over the entire sheet passing region W1.

Since the heat conductor 27b of the reflector 27 in the first embodiment of the present disclosure is in continuous contact with the high thermal conductor 26 over the entire sheet passing region W1, the heat conductor 27b can effectively transfer the heat of the reflector 27 to the high thermal conductor 26. Since the heat conductor 27b transfers heat from the reflector portion 27a to the high thermal conductor 26, the above-described configuration can reduce the temperature rise in the reflector portion 27a that receives the radiant heat from the halogen heaters 23.

Since the shield 28 in the first embodiment of the present disclosure is in contact with the reflector 27, heat transfers from the shield 28 to the reflector 27 via the contact 28b of the shield 28. As a result, the temperature rise of the shield 28 can be reduced.

As described above, the above-described structure according to the first embodiment of the present disclosure can reduce the temperature rise of the reflector 27 and the shield 28 and solve the problems caused by the temperature rise.

Specifically, reducing the temperature rise of the reflector 27 can prevent the reflection face from being discolored by the heat and prevent the reflectance from being reduced by the discoloration of the reflection face. In addition, reducing the temperature rise of the reflector 27 can relax or eliminate the restriction on the number of sheets printed per unit time and enhance the productivity of the image forming apparatus.

Reducing the temperature rise of the shield 28 can reduce the temperature rise of the rotator holder 29 that is caused by the temperature rise of the shield 28. As a result, since the temperature rise of the lubricant adhered to the rotator holder 29 is reduced, the occurrence of FP/UFP can also be reduced.

The heat transferred from the shield 28 to the high thermal conductor 26 via the reflector 27 and the heat transferred from the reflector 27 to the high thermal conductor 26 are used as heat for heating the fixing belt 21 at the nip N. As a result, the fixing belt 21 can be efficiently heated, and energy saving can be achieved.

Since the heat conductor 27b of the reflector 27 is in contact with the nip pressing face 240 of the nip formation pad 24, the heat conductor 27b can be in close contact with the high thermal conductor 26. As a result, since heat efficiently transfers from the heat conductor 27b to the high thermal conductor 26, the temperature rise in each of the reflector 27 and the shield 28 is effectively reduced.

The reflector 27 may be in direct contact with the high thermal conductor 26 or may be in indirect contact with the high thermal conductor 26 via a member having high thermal conductivity. Similarly, the shield 28 may be in direct contact with the reflector 27 or may be in indirect contact with the reflector 27 via a member having good thermal conductivity. The reflector 27 may be in direct contact with the inner circumferential surface of the fixing belt 21 without contacting the high thermal conductor 26. The reflector 27 and the high thermal conductor 26 may be a single part. Also, in the above-described case, since the heat conductor 27b of the reflector 27 is in contact with the nip pressing face 240 of the nip formation pad 24, the heat conductor 27b can be in close contact with the fixing belt 21. As a result, since heat efficiently transfers from the heat conductor 27b to the fixing belt 21, the temperature rise in each of the reflector 27 and the shield 28 is effectively reduced. Since the heat is efficiently transferred from the reflector 27 to the fixing belt 21 at the nip N, enhancing heating efficiency of the fixing belt 21 can also be expected.

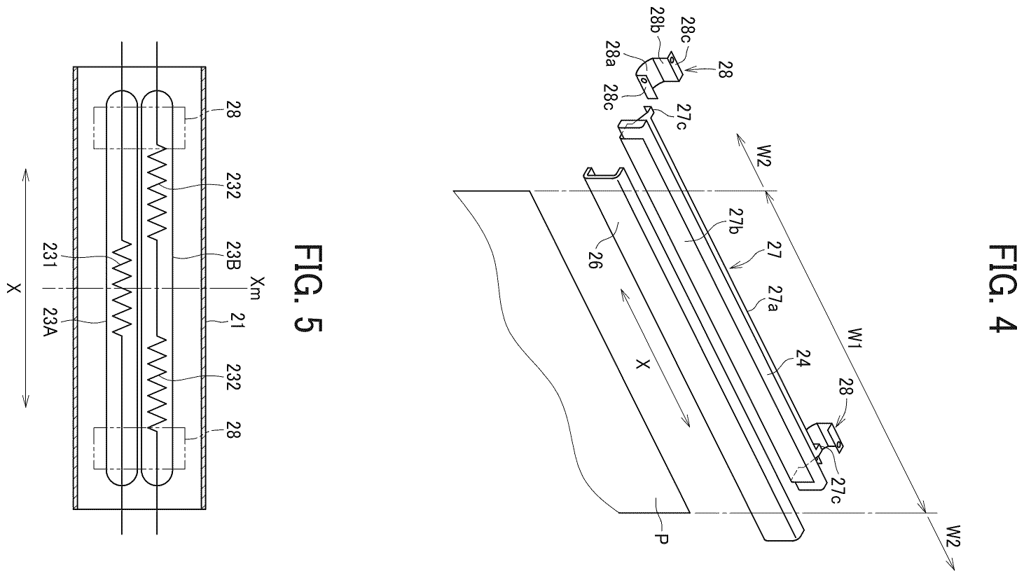

The fixing device 20 according to the first embodiment of the present disclosure includes two halogen heaters 23A and 23B as heat sources to heat the fixing belt 21. As illustrated in FIG. 5, one halogen heater 23A of the two halogen heaters 23 is a center heater as a central heat source to heat a center portion of the fixing belt 21 in the longitudinal direction, and the other halogen heater 23B is an end heater as an end heat source to heat both end portions of the fixing belt 21 in the longitudinal direction.

The center heater 23A includes a heat generation portion 231 disposed to heat a center region including the center Xm of the fixing belt 21 in the longitudinal direction. On the other hand, the end heater 23B includes two heat generation portions 232 disposed to heat both end portions of the fixing belt 21 outside the center region heated by the heat generation portion 231 of the center heater 23A in the longitudinal direction. The center heater 23A and the end heater 23B are configured so that the controller can independently control heat generation of the center heater 23A and heat generation of the end heater 23B.

When the fixing device 20 fixes the image onto a small sheet having a small width, only the center heater 23A generates heat in accordance with the size of the small sheet. On the other hand, when the fixing device 20 fixes the image onto a large sheet having a width larger than the width of the small sheet, the end heater 23B generates heat in addition to the center heater 23A in accordance with the size of the large sheet.

However, continuously fixing images onto the large sheets may cause the excessive temperature rise in the non-sheet-passing region of the fixing belt 21 because the large sheets do not consume heat in the non-sheet-passing region outside the sheet-passing region. To countermeasure the excessive temperature rise, the shield 28 is disposed at the outer end portion of each of the heat generation portions 232 of the end heater 23B and in the vicinity thereof. As a result, the shield 28 shields the non-sheet-passing region of the fixing belt 21 from the radiant heat to reduce the excessive temperature rise in the non-sheet-passing region of the fixing belt 21.

Since each of the shields 28 is disposed to shield the non-sheet-passing region of the fixing belt 21 from the radiant heat radiated by the heat generation portion 232 of the end heater 23B as described above, a portion of the shield 28 close to the heat generation portion 232 of the end heater 23B is particularly liable to be heated. As illustrated in FIG. 6, the shield 28 is disposed so as to face both the center heater 23A and the end heater 23B, but a portion 282 closer to the end heater 23B than to the center heater 23A is more easily heated than a portion 281 closer to the center heater 23A than to the end heater 23B. For this reason, the shield 28 in the first embodiment of the present disclosure contacts the reflector 27 at the portion 282 closer to the end heater 23B than to the center heater 23A. For this reason, the portion is referred to as a contact portion 282. The above-described structure increases the temperature gradient between the contact 28b of the shield 28 and the contact 27c of the reflector 27. As a result, the above-described structure can efficiently transfer heat from the shield 28 to the reflector 27 and effectively reduce the temperature rise in the shield 28.

The contact 28b of the shield 28 may not be necessarily disposed at a position close to the end heater 23B. For example, when the contact 28b of the shield 28 cannot be disposed at a position close to the end heater 23B due to the convenience of the component layout, the contact 28b may be disposed at a position close to the center heater 23A.

In the present disclosure, comparing a distance L1 from the center of the center heater 23A to the contact 28b and a distance L2 from the center of the end heater 23B to the contact 28b determines whether the contact 28b of the shield 28 is closer to the end heater 23B than to the center heater 23A. For example, if the length L2 from the center of the end heater 23B to the contact 28b is smaller than the length L1 from the center of the center heater 23A to the contact 28b (L1>L2), it is determined that the end heater 23B is closer to the contact 28b than to the center heater 23A. When a boundary 283 that is equidistant from the center of the center heater 23A and the center of the end heater 23B is across the contact 28b of the shield 28 (L1=L2), the shield 28 has portions at both sides of the boundary 283. In this case, a ratio between the portion of the contact 28b close to the center heater 23A and the portion of the contact 28b close to the end heater 23B determines whether the contact 28b of the shield 28 is closer to the end heater 23B than to the center heater 23A. If the portion of the contact 28b close to the end heater 23B is larger than the portion of the contact 28b close to the center heater 23A, it is determined that the contact 28b is disposed at the position close to the end heater 23B.

In order to efficiently transfer the heat of the reflector 27 and the shield 28 to the high thermal conductor 26, the reflector 27 is preferably made of a material having high thermal conductivity. Specifically, the thermal conductivity of the reflector 27 is preferably 200 W/m·k or more, more preferably 300 W/m·k or more, and further preferably 400 W/m·k or more.

### <Method of Measuring Thermal Conductivity>

The thermal conductivity is obtained by the following expression (1).

$$λ = ρ \times C \times α \qquad ( 1 )$$

where λ is thermal conductivity, ρ is density, C is specific heat, and α is thermal diffusivity. The values of the density (ρ), the specific heat (C), and the thermal diffusivity (α) for calculating the thermal conductivity (λ) are measured by the following measuring apparatuses and methods.

The present inventors measured the density (ρ) by using a dry automatic densitometer (trade name (TM): AccuPyc 1330 manufactured by SHIMADZU CORPORATION). The present inventors measured the specific heat (C) by using a differential scanning calorimeter (trade name (TM): DSC-60 manufactured by SHIMADZU CORPORATION) and sapphire as a reference material. The present inventors measured the specific heat (C) five times and used an average value at 50° C. The present inventors cut the elastic layer of the pressure roller into pieces having a length of 1 mm or less to prepare a measurement sample and measured the thermal diffusivity (α) by using a thermal diffusivity/conductivity measuring device (trade name (TM): ai-Phase Mobile 1u, manufactured by Ai-Phase co., ltd.).

### Configurations of Other Embodiments

Subsequently, other embodiments different from the above-described first embodiment are described. Differences from the above-described first embodiment are mainly described, and descriptions of the same portions are appropriately omitted.

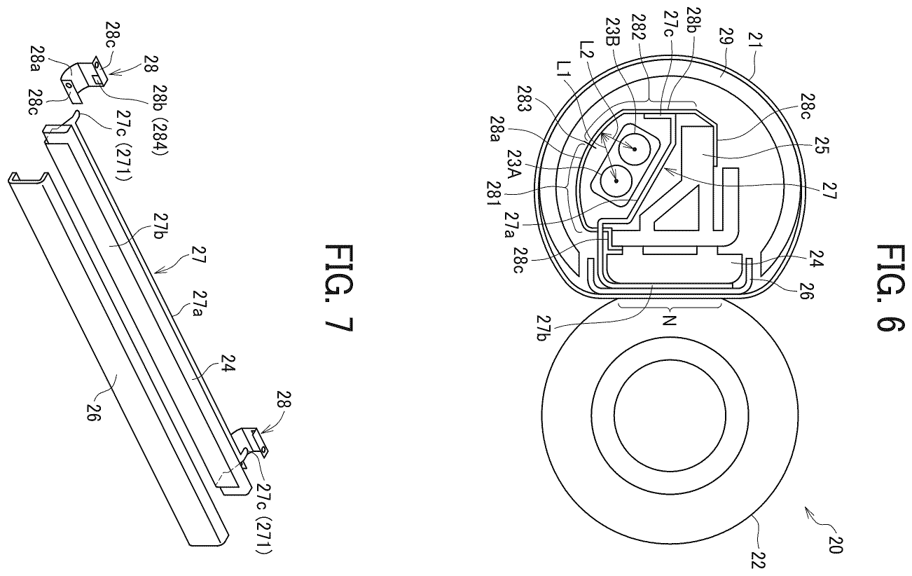

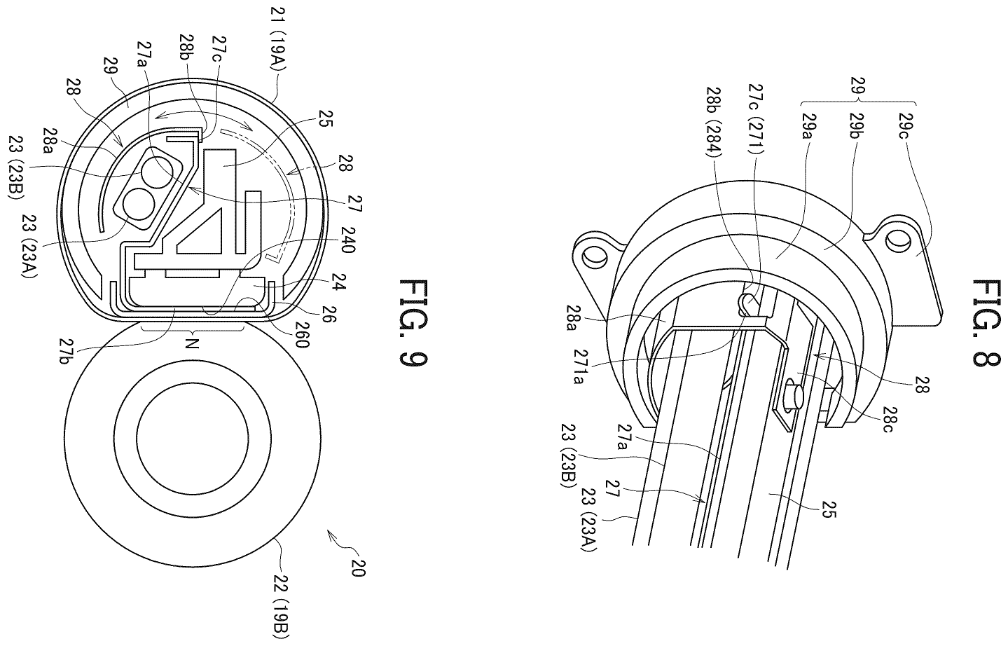

FIGS. 7 and 8 illustrate a configuration according to a second embodiment of the present disclosure.

In the second embodiment of the present disclosure illustrated in FIG. 7, each of the contacts 27c of the reflector 27 includes a projection 271 projecting from each of the longitudinal ends of the reflector 27 toward the shield 28. In this case, the contact 27c is not formed to be bent.

On the other hand, the shield 28 has holes 284, and the projections 271 of the reflector 27 are inserted into the holes 284, respectively.

As illustrated in FIG. 8, the reflector 27 is assembled to the shield 28, and inserting the projection 271 of the reflector 27 into the hole 284 of the shield 28 causes the projection 271 to come into contact with the shield at the edge of the hole 284. The projection 271 and the hole 284 that are in contact with each other enable heat transfer from the shield 28 to the reflector 27 via the contacts. In the above, the hole 284 functions as the contact 28b of the shield 28 in contact with the reflector 27.

The structure in which a side face 271a of the projection 271 that is inserted into the hole 284 to be in contact with the shield 28 at the edge of the hole 284 can allow the positional deviation between the reflector 27 and the shield 28.

Even if the reflector 27 is slightly shifted from the shield 28 in an insertion direction that the projection 271 inserted into the hole 284 or in the opposite direction, the projection 271 can contact the shield 28 at the edge of the hole 284.

Contrary to the configuration illustrated in FIG. 8, the projection may be provided on the shield 28, and the reflector 27 may have the hole. One of the reflector 27 and the shield 28 may have a hole into which a part of the other one of the reflector 27 and the shield 28 can be inserted.

FIG. 9 illustrates a configuration according to a third embodiment of the present disclosure.

In the third embodiment of the present disclosure illustrated in FIG. 9, the shield 28 is configured to be movable between a shielding position indicated by an alternate long and two short dashes line and a retracted position indicated by a solid line inside the loop of the fixing belt 21.

The shield 28 moved to the shielding position indicated by the solid line faces the halogen heater 23 and shields the fixing belt 21 from the radiant heat radiated from the halogen heater 23. In contrast, the shield 28 moved to the retracted position indicated by the alternate long and two short dashes line does not face the halogen heater 23, and therefore, the radiant heat radiated from the halogen heater 23 is applied to the fixing belt 21 without being shielded by the shield 28.

As described above, the shield 28 may be movable. In this case, the contact 28b of the shield 28 moved to the shielding position contacts the contact 27c of the reflector 27 to enable transferring the heat from the shield 28 to the reflector 27. As a result, the heat transfer from the shield 28 to the reflector 27 enables reducing the temperature rise in the shield 28.

The embodiments of the present disclosure have been described above. In the embodiments of the present disclosure, the configuration including the two halogen heaters 23A and 23B as the heat sources has been described as an example, but the present disclosure may also be applied to a configuration including one heat source or three or more heat sources.

The present disclosure is not limited to applying to the fixing device in the electrophotographic image forming apparatus. The present disclosure may be applied to, for example, a dryer in an inkjet image forming apparatus to dry liquid such as ink applied to the sheet, a laminator that heats, under pressure, a covering member such as a film onto the surface of the sheet such as paper, and a heat sealer that seals a seal portion of a packaging material with heat and pressure.

The above-described embodiments of the present disclosure have at least the following aspects.

### [First Aspect]

In a first aspect, a heating device includes a first rotator, a second rotator, a heater, a nip formation pad, a reflector, and a shield. The second rotator faces the first rotator. The heater heats the first rotator. The nip formation pad is inside a loop of the first rotator to form a nip between the first rotator and the second rotator. The nip formation pad has a nip side face facing an inner circumferential surface of the first rotator. The reflector reflects radiant heat radiated from the heater toward the inner circumferential surface of the first rotator. The reflector contacts the nip side face of the nip formation pad. The shield contacts the reflector and shields the first rotator from the radiant heat radiated from the heater.

### [Second Aspect]

In a second aspect, a heating device includes a first rotator, a second rotator, a heater, a nip formation pad, a high thermal conductor, a reflector, and a shield. The second rotator faces the first rotator. The heater heats the first rotator. The nip formation pad is inside a loop of the first rotator to form a nip between the first rotator and the second rotator. The high thermal conductor is between the nip formation pad and an inner circumferential surface of the first rotator. The high thermal conductor has thermal conductivity higher than thermal conductivity of the nip formation pad. The reflector reflects radiant heat radiated from the heater toward an inner circumferential surface of the first rotator. The reflector contacts the high thermal conductor. The shield contacts the reflector and shields the first rotator from the radiant heat radiated from the heater.

### [Third Aspect]

In a third aspect, the heater in the heating device according to the first aspect or the second aspect, the heater includes a center heater and an end heater. The center heater heats a center portion of the first rotator in a longitudinal direction of the first rotator. The end heater heats both ends of the first rotator in the longitudinal direction. The shield includes a contact portion contacting the reflector, and the contact portion is closer to the end heater than to the center heater.

### [Fourth Aspect]

In a fourth aspect, the reflector in the heating device according to any one of the first to third aspects has thermal conductivity equal to or greater than 200 W/m×K.

### [Fifth Aspect]

In a fifth aspect, one of the reflector and the shield in the heating device according to any one of the first to fourth aspects has a hole into which a part of another of the reflector and the shield is inserted, and the part of said another of the reflector and the shield inserted into the hole contacts the one of the reflector and the shield.

### [Sixth Aspect]

In a sixth aspect, the heating device according to any one of the first to fifth aspects further includes a rotator holder holding both ends of an inner circumferential surface of the first rotator in a longitudinal direction of the first rotator and lubricant adhering to the rotator holder

### [Seventh Aspect]

In a seventh aspect, a fixing device includes the heating device according to any one of the first to sixth aspects.

### [Eighth Aspect]

In an eighth aspect, an image forming apparatus includes the heating device according to any one of the first to sixth aspects or the fixing device according to the seventh aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
a first rotator;
a second rotator facing the first rotator;
a heater to heat the first rotator;
a nip formation pad inside a loop of the first rotator to form a nip between the first rotator and the second rotator,
the nip formation pad having a nip side face facing an inner circumferential surface of the first rotator;
a reflector to reflect radiant heat radiated from the heater toward the inner circumferential surface of the first rotator, the reflector contacting the nip side face of the nip formation pad; and
a shield:
contacting the reflector; and
shielding the first rotator from the radiant heat radiated from the heater.

2. The heating device according to claim 1, further comprising:
a high thermal conductor between the nip formation pad and the inner circumferential surface of the first rotator, the high thermal conductor having thermal conductivity higher than thermal conductivity of the nip formation pad,
wherein the reflector has:
one face contacting the nip side face; and
another face, opposite to the one face, contacting the high thermal conductor.

3. The heating device according to claim 1,
wherein the heater includes:
a center heater to heat a center portion of the first rotator in a longitudinal direction of the first rotator; and
an end heater to heat both ends of the first rotator in the longitudinal direction,
the shield includes a contact portion contacting the reflector, and
the contact portion is closer to the end heater than to the center heater.

4. The heating device according to claim 1,
wherein the reflector has thermal conductivity equal to or greater than 200 W/m×K.

5. The heating device according to claim 1,
wherein one of the reflector and the shield has a hole into which a part of another of the reflector and the shield is inserted, and
the part of said another of the reflector and the shield inserted into the hole contacts the one of the reflector and the shield.

6. The heating device according to claim 1, further comprising:
a rotator holder holding both ends of an inner circumferential surface of the first rotator in a longitudinal direction of the first rotator; and
lubricant adhering to the rotator holder.

7. A fixing device comprising the heating device according to claim 1.

8. An image forming apparatus comprising the heating device according to claim 1.

9. A heating device comprising:
a first rotator;
a second rotator facing the first rotator;
a heater to heat the first rotator;
a nip formation pad inside a loop of the first rotator to form a nip between the first rotator and the second rotator;
a high thermal conductor between the nip formation pad and an inner circumferential surface of the first rotator, the high thermal conductor having thermal conductivity higher than thermal conductivity of the nip formation pad;
a reflector to reflect radiant heat radiated from the heater toward an inner circumferential surface of the first rotator, the reflector contacting the high thermal conductor; and
a shield:
contacting the reflector; and
shielding the first rotator from the radiant heat radiated from the heater.

10. The heating device according to claim 9,
wherein the heater includes:
a center heater to heat a center portion of the first rotator in a longitudinal direction of the first rotator; and
an end heater to heat both ends of the first rotator in the longitudinal direction,
the shield includes a contact portion contacting the reflector, and
the contact portion is closer to the end heater than to the center heater.

11. The heating device according to claim 9,
wherein the reflector has thermal conductivity equal to or greater than 200 W/m×K.

12. The heating device according to claim 9,
wherein one of the reflector and the shield has a hole into which a part of another of the reflector and the shield is inserted, and
the part of said another of the reflector and the shield inserted into the hole contacts the one of the reflector and the shield.

13. The heating device according to claim 9, further comprising:
a rotator holder holding both ends of an inner circumferential surface of the first rotator in a longitudinal direction of the first rotator; and
lubricant adhering to the rotator holder.

14. A fixing device comprising the heating device according to claim 9.

15. An image forming apparatus comprising the heating device according to claim 9.
